(19) United States
(12) Patent Application Publication
(10) Pub. No.: US 2006/0244989 A1
(43) Pub. Date: Nov. 2, 2006

(54) Systems for and methods of presenting digital images

(76) Inventor: Charles Evans, Corvallis, OR (US)

Correspondence Address: BRINKS HOFER GILSON & LIONE/MARVELL, P.O. BOX 10395, CHICAGO, IL, 60610, US

(21) Appl. No.: 11/105,816

(22) Filed: Apr. 13, 2005

(51) Int. Cl. G06F 3/12

(52) U.S. Cl. 358/1.15

(57) ABSTRACT

An electronic device includes a housing having a first readable-optical-medium-receiving portion and a medium-removal portion, the first readable-optical-medium-receiving portion operable to receive a first optical storage medium carrying data representing a first image. The device further includes a first renderer coupled to the housing and operable to render the first image on a presentation medium at least partially disposed within the housing, the medium-removal portion operable to allow removal of the presentation medium from the housing.

### BACKGROUND

Typically, when an image captured by a digital camera is to be printed, the use of a personal computer (PC) is required. For example, after the digital camera captures and stores an image, the digital camera and PC may be coupled to each other via a communication cable. Alternatively, the digital camera may store the image on a removable storage device (RSD), such as a flash memory card, which may be removed from the camera and coupled to a data port of the PC. Subsequently, the PC captures image data from the digital camera or memory card, converts the captured image data into print data, and outputs the converted print data to a printer for processing.

Alternatively, the image to be printed may be stored on a portable storage medium, such as a compact disc (CD) or digital versatile disc (DVD). In this case, the PC captures image data from the CD or DVD, converts the captured image data into print data, and outputs the converted print data to a printer for processing.

In either case, the necessity of using a PC, from both time-consumption and equipment-requirement standpoints, unduly complicates the digital-image printing process. Some existing printers accept RSDs directly and allow a user to select images stored on the RSD and directly print them via the printer, but such printers have limited utility for archiving image files and cannot transfer such files to other more suitable archival storage media without the use of a PC.

### SUMMARY

According to an aspect of the invention, an electronic device includes a housing having a first readable-optical-medium-receiving portion and a medium-removal portion, the first readable-optical-medium-receiving portion operable to receive a first optical storage medium carrying data representing a first image. The device further includes a first renderer coupled to the housing and operable to render the first image on a presentation medium at least partially disposed within the housing, the medium-removal portion operable to allow removal of the presentation medium from the housing.

The electronic device allows a user to print images stored on an optical storage medium without requiring the use of a PC, and also allows the user to archive image data stored on other storage media, such as an RSD, to the optical storage medium.

### BRIEF DESCRIPTION OF THE DRAWINGS

FIG. 1 is a side view of an electronic device according to an embodiment of the invention; and

FIG. 2 is a functional block diagram of the electronic device of FIG. 1 according to an embodiment of the invention.

### DETAILED DESCRIPTION

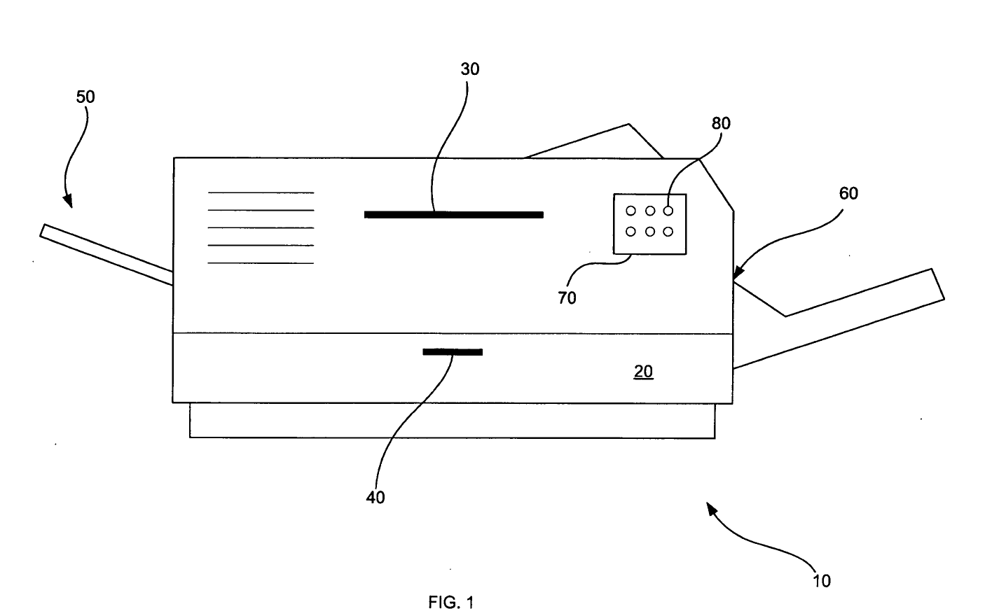

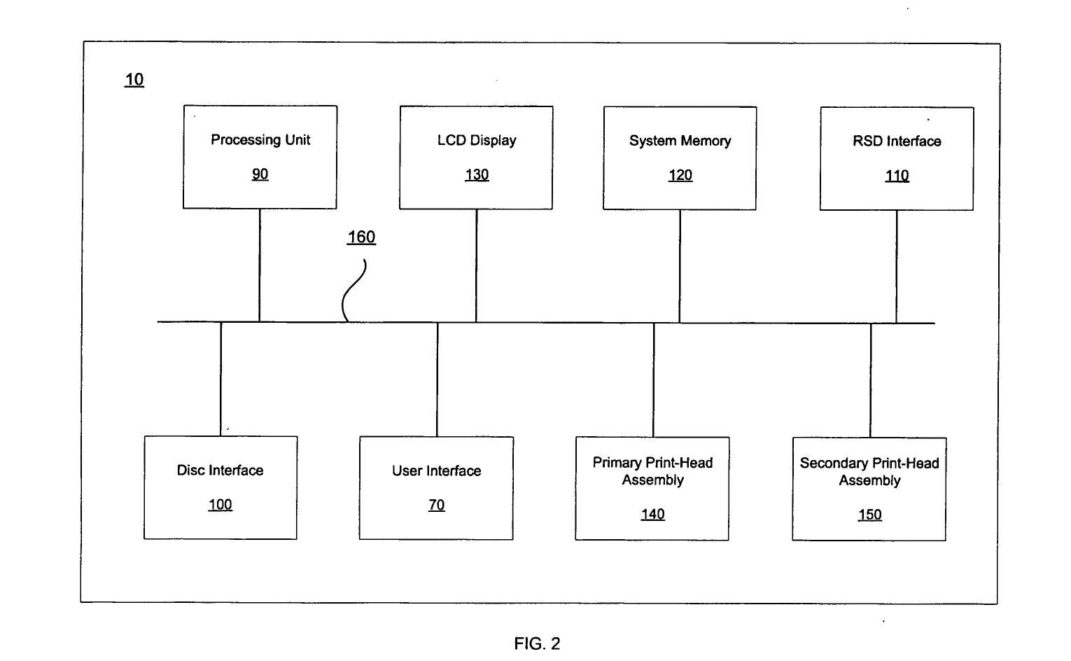

FIGS. 1 and 2 illustrate an electronic device, such as a printer 10, according to one or more embodiments of the invention. By way of example, and not limitation, the printer 10 may comprise a conventional inkjet or laser printer. The components of the printer 10 described herein are exemplary and are not intended to suggest any limitation as to the scope of use or functionality of embodiments of the invention. The described embodiments of the printer 10 should not be interpreted as having any particular dependency or requirement relating to any one component or combination of components illustrated in and described with reference to FIGS. 1 and 2.

Referring to the embodiment illustrated in FIG. 1, the printer 10 includes a housing 20. The housing 20 may include a first optical-medium-receiving portion, such as a conventional slot 30, operable to receive a CD, DVD, or other type of optical storage media (not shown). Alternatively, the first optical-medium-receiving portion may include a conventional tray to receive an optical disc. The housing 20 may further include a second readable-medium-receiving portion, such as a port 40. The port 40 may comprise a universal-serial-bus (USB) port or other port operable to receive an RSD, such as a flash memory card. In alternative embodiments, the second readable-medium-receiving portion may include optical or other wireless sensors operable to receive data from an RSD or other storage device via an optical or wireless communications link, or may include a port such as an Ethernet port adapted to receive data over a suitable wired communications link.

The housing 20 may further include a conventional paper-feed assembly 50 and a presentation-medium-removal portion, such as a conventional slot 60, from which a presentation medium, such as paper, transparent plastic or any other medium on which an image can be printed, can be removed from the housing 20. For purposes of the ensuing discussion, it will be assumed that paper is the presentation medium employed. Additionally, the term “image” should be construed to include alphanumeric characters and/or graphical depictions.

The printer 10 may further include a user interface 70 that can be used to control printer function. The user interface 70 may include one or more controls, such as buttons 80, that, when employed by a user, instruct the printer 10 to perform functions including those described hereinafter.

Referring now to FIGS. 1 and 2, the printer 10 may further include a processing unit 90, a disc interface 100, an RSD interface 110, a system memory 120, an electronic display 130, such as a color or monochrome liquid-crystal display (LCD), a first renderer, such as a primary print-head assembly 140, and a second renderer, such as a secondary print-head assembly 150. A system bus 160 may interconnect the components of the printer 10.

As described above, the disc slot 30 is operable to receive an optical disc on which is stored image data. Upon receipt of the optical disc by the disc slot 30, the disc interface 100 reads the image data from the disc. Upon activation of one or more user interface controls 80 by the user, the processing unit 90 converts the image data into print data by, for example, employing a conventional printer driver (not shown). The processing unit 90 then employs the primary print-head assembly 140 to print the image represented by the print data to one or more sheets of paper. After the image has been printed to a sheet of paper, the sheet may be removed from the housing 20 via the slot 60 by, for example, rollers (not shown) in a conventional manner.

As described above, the port 40 is operable to receive an RSD on which is stored image data. Upon receipt of the RSD by the port 40, the RSD interface 110 reads the image data from the RSD. In a manner similar to that described above, upon activation of one or more user interface controls 80 by the user, the processing unit 90 converts the image data into print data and employs the primary print-head assembly 140 to print the image represented by the print data to one or more sheets of paper. After the image has been printed to a sheet of paper, the sheet may be removed from the housing 20 via the slot 60.

Alternatively, the user may utilize the user interface controls 80 to view and select images stored on the RSD placed in the port 40 and thereafter transfer or archive the files corresponding to these selected images to an optical disc in the port 30 via the disc interface 100. More specifically, responsive to input from the user via the user interface controls 80, the RSD interface 100 retrieves selected image data from the RSD in the port 40. The RSD interface 100 transfers this image data via the system bus 160 to the disc interface which, in turn, transfers the image data to the optical disc in the port 30. In this way, the user may store image data on the optical disc without the need for a PC. Storage on optical storage media is preferable to storage on RSD or other electronic storage devices since the retention rate for such optical storage is longer and less susceptible to corruption.

Similarly, upon receipt of a disc by the slot 30, the disc interface 100 may read image data stored on the disc. Upon activation of one or more user interface controls 80 by the user, the processing unit 90 employs the RSD interface 110 to write the image data to an RSD received by the RSD interface 110, thereby storing the image data on the RSD. This feature may be convenient, for example, if a user wants to take images with him or her via a digital camera, for example. Once the user transfers the image data from the optical disc to the RSD, the user can then insert the RSD in the digital camera and show the images to others.

In another embodiment, the processing unit 90 may employ, for example, a video driver (not shown) to drive the LCD display 130 and display one or more images represented by the image data read from a disc or RSD received by the housing 20. Consequently, the user, by activating one or more user interface controls 80, may review the images via the LCD display 130 and, if desired, instruct the printer 10 to print one or more of the displayed images.

In a further embodiment, upon activation of a user interface control 80 by the user, the processing unit 90 may store in the system memory 120 image data read from a disc or RSD received by the housing 20. Consequently, at a later time, the user, by activating one or more user interface controls 80, may review the stored images via, for example, the display 130 and, if desired, instruct the printer 10 to print one or more of the stored images. Moreover, the user may thus be able to transport the printer 10, thereby using the printer itself as a portable image-data-storage device.

In yet another embodiment, the disc interface 100 is operable to read image data from a DVD. Accordingly, the processing unit 90 may employ the video driver to drive the LCD display 130 with this video image data and display one or more video frames from this video image data read from the DVD. By activating one or more user interface controls 80, the user may review the frames of video images via the LCD display 130 and select one or more frames for printing, and may also control the printer 10 to print the selected images.

In another embodiment, the user, by activating one or more user interface controls 80, may select one or more images to be printed on a surface or label attached to a surface of a disc present in the slot 30. These images may comprise at least one alphanumeric character generated to the display 130 by, for example, a text editor (not shown) stored in the system memory 120 and executed by the processing unit 90. After receiving the user's selection, the processing unit 90 employs the secondary print-head assembly 150 to print the selected image to the label or disc surface.

The described embodiments of the invention are operational with numerous general purpose or special purpose computing system environments or configurations. Examples of well known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

Although embodiments of the printer 10 described herein may allude, for exemplary purposes, to certain types of computer-readable media that the printer includes or with which the printer interacts, it should be recognized that such embodiments may include or interact with a variety of computer-readable media.

Computer-readable media can be any available media that can be included and/or accessed by the printer 10 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, DVD or other optical disk storage, magnetic cassettes, magnetic tape, magnetic disk storage or other magnetic storage devices, or any other medium that can be used to store information and that can be included and/or accessed by the printer 10. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. An electronic device, comprising:
a housing having a first readable-optical-medium-receiving portion and a medium-removal portion, the first readable-optical-medium-receiving portion operable to receive a first optical storage medium carrying data representing a first image; and
a first renderer coupled to the housing and operable to render the first image on a presentation medium at least partially disposed within the housing, the medium-removal portion operable to allow removal of the presentation medium from the housing.

2. The electronic device of claim 1 wherein the presentation medium comprises paper.

3. The electronic device of claim 1, further comprising an electronic display operable to display the first image.

4. The electronic device of claim 1 wherein the first readable-optical-medium-receiving portion comprises a compact disc (CD) read/write drive.

5. The electronic device of claim 1 wherein the first readable-optical-medium-receiving portion comprises a digital versatile disc (DVD) read/write drive.

6. The electronic device of claim 1, further comprising a second readable-medium-receiving portion operable to receive a second readable medium.

7. The electronic device of claim 7, further comprising a processing unit operable to store the data contained on the first optical storage medium on the second readable medium.

8. The electronic device of claim 7 wherein the second readable medium comprises a flash memory device.

9. The electronic device of claim 1, further comprising a second renderer operable to render a second image on a surface of the first optical storage medium.

10. The electronic device of claim 1 wherein the first image comprises a video frame.

11. The electronic device of claim 1, further comprising a memory operable to store the first image.

12. A printer, comprising:
a housing having a first readable-optical-medium-receiving portion and a medium-removal portion, the first readable-optical-medium-receiving portion operable to receive a first readable medium carrying data representing a first image;
a first renderer coupled to the housing and operable to render the first image on a presentation medium at least partially disposed within the housing, the medium-removal portion operable to allow removal of the presentation medium from the housing;
a feed assembly operable to enable the housing to receive the presentation medium; and
a user interface operable to allow a user to control operation of the printer.

13. The printer of claim 12 wherein the first renderer comprises a laser printer assembly operable to render the first image on the presentation medium.

14. The printer of claim 12, further comprising a second renderer operable to render a second image on a surface of the first readable medium.

15. The printer of claim 12 wherein the first readable-optical-medium-receiving portion comprises a CD or DVD read-write drive.

16. The printer of claim 12 further comprising:
a second readable-medium-receiving portion operable to receive a second readable medium; and
a processing unit operable to store the data contained on the first optical storage medium on the second readable medium.

17. A method, comprising:
receiving with a first readable-medium-receiving portion of a housing a first readable medium carrying data representing a first image; and
rendering the first image on a presentation medium at least partially disposed within the housing, the presentation medium removable from the housing via a medium-removal portion of the housing.

18. The method of claim 17 wherein the presentation medium comprises paper.

19. The method of claim 17 wherein the first readable medium comprises a flash memory device.

20. The method of claim 17 wherein the first readable medium comprises a modulated data signal.
